(19) United States
(12) Patent Application Publication
(10) Pub. No.: US 2023/0099557 A1
(43) Pub. Date: Mar. 30, 2023

(54) RULE EVALUATION FOR RELATED DATA METRICS IN REAL-TIME DATA STREAM

(71) Applicant: Salesforce, inc., San Francisco, CA (US)

(72) Inventors: Ashish Thapliyal, Frisco, TX (US); Rajiv Karuthethil, Sunnyvale, CA (US); Lingyu Deng, Redmond, WA (US); Sudheer Kumar Kanaka, Bangaore (IN); Vishal Meghani, San Francisco, CA (US)

(21) Appl. No.: 17/934,991

(22) Filed: Sep. 23, 2022

(30) Foreign Application Priority Data
Sep. 23, 2021 (IN) 202141043161

(51) Int. Cl. G06F 3/0484; G06F 16/2455; G06F 3/0481

(52) U.S. Cl. CPC G06F 3/0484; G06F 3/0481; G06F 16/24568

(57) ABSTRACT

An application server may receive, via a user interface, a first user input including a first definition for a first set of data metrics configured for a tenant in a multi-tenant system and a second user input including a second definition for a second set of data metrics configured for the tenant in the multi-tenant system. The application server may further receive a real-time data stream associated with the tenant in the multi-tenant system, and evaluate, in a batch manner, one or more rules based on ingesting the real-time data stream into the first definition for the first set of data metrics and the second definition for the second set of data metrics.

### CROSS REFERENCE

The present Application for Patent claims the benefit of Indian Provisional Patent Application No. 202141043161 by Thapliyal et al., entitled “RULE EVALUATION FOR RELATED DATA METRICS IN REAL-TIME DATA STREAM,” filed Sep. 23, 2021, assigned to the assignee hereof, and expressly incorporated by reference in its entirety herein.

### FIELD OF TECHNOLOGY

The present disclosure relates generally to database systems and data processing, and more specifically to rule evaluation for related data metrics in real-time data stream.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

A cloud platform may run on a relational database, and data within the relational database may be configured in tables with schemas or metadata structures (e.g., referred to as objects). Such a cloud platform may support content distribution to users. The cloud platform may also support a number of applications and pages for viewing CRM information, updating data records, or performing other CRM or data-related activities. Users may access these applications and pages on different user devices. In some cases, the cloud platform may support a service that supports a definition for one or more data metrics configured for a tenant in a multi-tenant system. Some systems supporting the definition for one or more data metrics with data records can be improved.

### BRIEF DESCRIPTION OF THE DRAWINGS

FIG. 1 illustrates an example of a data processing at an application server system that supports rule evaluation for related data metrics in real-time data stream in accordance with aspects of the present disclosure.

FIG. 2 illustrates an example of a system that supports rule evaluation for related data metrics in real-time data stream in accordance with aspects of the present disclosure.

FIG. 3 illustrates an example of a process flow that supports rule evaluation for related data metrics in real-time data stream in accordance with aspects of the present disclosure.

FIG. 4 illustrates an example of a user interface that supports rule evaluation for related data metrics in real-time data stream in accordance with aspects of the present disclosure.

FIG. 5 illustrates an example of a user interface that supports rule evaluation for related data metrics in real-time data stream in accordance with aspects of the present disclosure.

FIG. 6 illustrates an example of a user interface that supports rule evaluation for related data metrics in real-time data stream in accordance with aspects of the present disclosure.

FIG. 7 shows a block diagram of an apparatus that supports rule evaluation for related data metrics in real-time data stream in accordance with aspects of the present disclosure.

FIG. 8 shows a block diagram of a data processing component that supports rule evaluation for related data metrics in real-time data stream in accordance with aspects of the present disclosure.

FIG. 9 shows a diagram of a system including a device that supports rule evaluation for related data metrics in real-time data stream in accordance with aspects of the present disclosure.

FIGS. 10 through 13 show flowcharts illustrating methods that support rule evaluation for related data metrics in real-time data stream in accordance with aspects of the present disclosure.

### DETAILED DESCRIPTION

A system (e.g., a cloud-based system supporting customer relationship management (CRM) solutions) may support a number of applications, pages, or both for displaying components. These components may display information, perform defined actions, provide links to other applications (e.g., third-party applications outside the cloud-based system), or provide any number of other features as indicated in the component definitions. A tenant of a multi-tenant database may store information and data for users, customers, organizations, etc. in a database. As depicted herein, a cloud platform may support multiple data records or data objects for multiple tenants. A cloud platform may thus support a data platform for customers. Such a cloud platform (e.g., a multi-tenant cloud platform) may also provide data processing and analytics solutions within a relational database (e.g., referred to as a core platform). In the cloud platform, data may be presented or structured as an object (e.g., a data table schema or metadata structure). Objects may be queried by various services and clients supported by the cloud platform.

In some instances, customers of a cloud platform may be unable to generate real-time metrics and actions from stream data sources that would provide them timely insights by enabling cross functional orchestration. In some cases, the cloud platform may support a service that supports segmenting users into groups based on profiles and other attributes. These segments may be used for marketing purposes, such as content distribution, to a particular set of a target users having some attribute similarities. With the enabled control events for data stream, segmentation and activation status change, all the control events may be available for consumption from an internal database system (e.g., core) as record level events on the representational entities using which end users may be able build flows and triggers. In some aspects, a cloud platform may support insights. Insights may be or may include a definition for one or more data metrics configured for a tenant in a multi-tenant system. However, in some cases (e.g., some applications such as a customer data platform), insights may not be generated for real-time data stream.

Aspects of the present disclosure support rule evaluation for related data metrics in real-time data stream. In some examples, the calculated insights may allow customers to define or author metrics on their data. According to aspects depicted herein, the calculated insights can be defined not only on data model, but also on other calculated insights and with more aggregation functionalities. Once the calculated insight is defined, techniques depicted herein provide for periodic computation of metrics and making them available for low latency querying. Additionally, or alternatively, enhanced application programming interfaces (APIs) may be added to manage the calculated insights. The calculated insights also support additional ranking or bucketing functions and more datetime functions allowing calculated insights creation with sub/nested queries and calculated insights creation on top of existing calculated insights. The insights calculation (according to a definition) as depicted here may be performed by building data analytics and business insights capabilities to empower customers with the right information at the right time to drive data-driven engagements, decisions, and automated flows. To solve the limitation of utilizing real-time data stream in generating insights according to a definition, the present disclosure provides ingesting the real-time data stream into a definition (according to a formula). Additionally, to enrich the aggregation functionalities and fulling customer scenarios, the present disclosure provides for calculating multiple insights which are interconnected.

The insights generated using real-time data stream may utilize real-time data streaming analytics service to analyze streaming data in real time. Data cloud streaming insights may produce sophisticated insights on streaming data from thousands of sources such as website/mobile clickstreams, internet of things (IoT) signals, database event streams, financial transactions, social media feeds, customer profile updates, and location-tracking events. The collected data is analyzed and available in milliseconds to enable real-time analytics (such as real-time anomaly detection, business process orchestration, and real time alerts). Upon generating the insights, aspects of the present disclosure may provide for an alert generation system. For example, if the system depicted herein may receive one or more rules corresponding to an action. The system may then receive a real-time data stream associated with the tenant in the multi-tenant system. Upon receiving the real-time data stream, the system may evaluate the one or more rules based on ingesting the real-time data stream into the definition for the one or more data metrics. That is, the system may calculate an insight using the real-time data stream. According to some examples, the calculated insights may have reference to another calculated insight. Based on the calculated insight, the system may determine whether the calculated insight satisfies one or more rules for triggering an action. The system may then trigger the action based on evaluating the one or more rules.

Aspects of the disclosure are initially described in the context of an environment supporting an on-demand database service. Aspects of the disclosure are further illustrated by and described with reference to process flow and user interfaces. Aspects of the disclosure are further illustrated by and described with reference to apparatus diagrams, system diagrams, and flowcharts that relate to rule evaluation for related data metrics in real-time data stream.

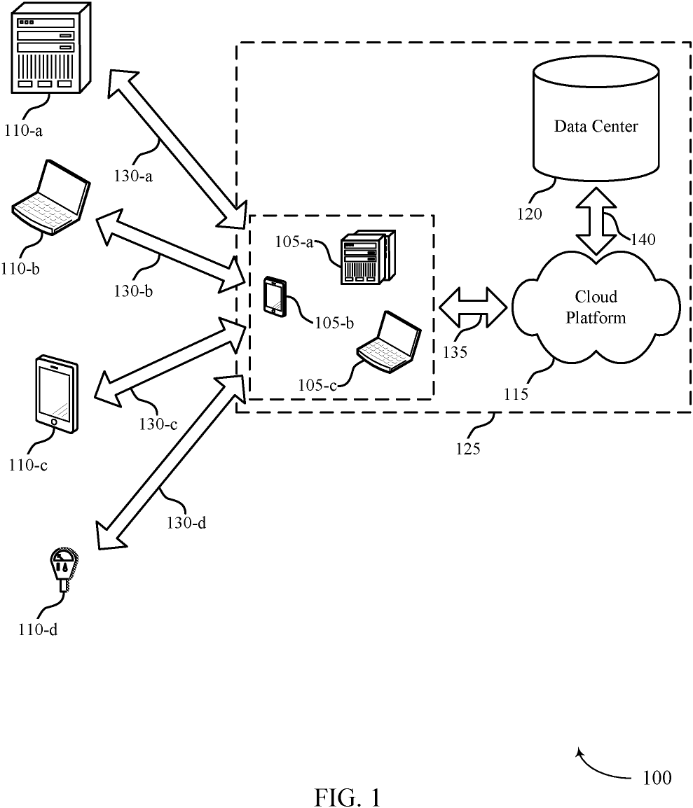

FIG. 1 illustrates an example of a system 100 for cloud computing that supports rule evaluation for related data metrics in real-time data stream in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants. As such, performance inefficiencies for a first tenant (e.g., an inefficient use of processing resources at scale) may potentially affect one or more other tenants sharing resources with the first tenant. Analyzing performance metrics and providing performance solutions for a specific tenant may improve system performance and resource availability both to the specific tenant and to other tenants sharing resources with the specific tenant in the multi-tenant system.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support generating insights within the multi-tenant system, for example, by ingesting real-time data stream into a definition for one or more data metrics. In some cases, the system 100 may implement rules to enable relatively generation of insights such that the generated insights include a reference to another generated insight.

Some systems may implement relational database systems may support a plurality of data objects, where each object is associated with a data table, and each row of the table corresponds to an instance of the object. In some aspects, a cloud platform may support insights. Insights may be or may include a definition for one or more data metrics configured for a tenant in a multi-tenant system. However, in some cases (e.g., some applications such as a customer data platform), insights may not be generated for real-time data stream.

Aspects of the present disclosure may be used to generate insights by ingesting real-time data stream into a definition for one or more data metrics. In some examples, the generated insights may include a reference to another generated insight. Aspects depicted herein may further be utilized to generate an alert based on ingesting the real-time data stream into the definition. This stream and event driven architecture may enable applications that can leverage real time insights and event driven architecture and make real time insights available for segmentation for customer experience (user added and user removed from a segment) centric use cases. In addition, this stream and event driven architecture may provide for intelligent routing (service cloud), sending notification to if a case is escalated or not worked upon, in IoT to filter streaming device, in financial services (detect fraudulent or suspicious transactions), in real-time transportation tracking, in IoT smart meter, enabling business processes, and enabling loyalty. In some examples, the stream and event driven architecture may be used for service and support, data replication, and profile update synchronization.

As depicted herein, the streaming data and insights may be collected by system 100 in real time at high volume. In some examples, the insights generated by the system 100 may include a reference to (or be a child to) another insight (e.g., parent insight). Additionally, or alternatively, a rule based action on this data may ensure that customers get highly curated and useful output and outstream to be used in other applications to be able to drive meaningful outcomes. A data action rule defines the specific actions to take when certain conditions are met. A basic action rule may use an if-then statement to associate a condition (if) with an action (then). The rule states what action to perform when a condition is true. One or more aspects of the present disclosure provide for techniques to create a data action based on meeting a threshold on streaming data, streaming insights or a calculated insight. Once a condition is met, data actions may be triggered and pushed to the predefined data action destinations. Additionally, or alternatively, users may register or otherwise provide data action targets to the system 100.

As one example, the system 100 may support a company A which is an extended warranty service provider for consumer electronics and appliances. Company A may have large enterprise contracts with major retailers. Recently one of their large accounts may notify company A that customers receiving warranty services from company A are unhappy and negatively impacting the brand and they might consider switching to a different provider and they asked company A to improve the quality of service and manage customer escalations with a high level of care. John Doe may be a data engineer for company A works in creating and building data systems that can enable a number of business processes for company A and are focused on improving large account retention. He may be asked by the business leader responsible for the large account to create a solution to identify the customers with issues quickly and organize managed care to improve the experiences As a solution, John may enable a business process based on real-time insight to quickly log support tickets as soon as a customer previously known to have good experience posts a negative review and is a customer of a large retailer. With logging of the service ticket, a representative from company A may call the customer and may ensure that the warranty claim is managed well and the customer is happy.

John’s employer may use system 100 and may like to use new streaming insights and data action framework to achieve the above scenario. In such a case, a customer of a large account just rated service with single star review, may be intercepted by the streaming insight. For example, the system 100 may utilize the insights that reflect that “this customer has historically been a happy customer with company A >90 and for the year” historic calculation from regular insight. In some examples, the system 100 may generate the insight reflecting “this customer has historically been a happy customer with company A >90 and for the year” by including a reference to another insight. As this customer meet the criteria customers with poor experience and are generally happy customer and the customer belongs to company A which is categorized as a “large retailer,” company A may trigger a data action alert. Upon triggering the data action alert, the system 100 may transmit the payload to a core event bus. With the insights generation flow, the system 100 may create a service ticket in the service cloud and a representative may contact the customer to improve the experience.

As another example, a customer may make a purchase in a specific product category, and get double loyalty points. the system 100 may send an email with an updated point score. In another example, the system 100 may utilize the rule evaluation for real-time data stream to let workers know when inventory is low or if there’s an urgent service appointment for them to get to. In some cases, the system 100 may utilize the rule evaluation for real-time data stream for sending renewal notices, usage limits, database size, and critical incident notification. The system may also utilize the rule evaluation for real-time data stream for account-level notifications (hourly or daily on demand metrics about account level thresholds), threshold messages (e.g., number visitors are higher or lower in a given time period) and pricing update triggers (update customers with pricing update in near real time).

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

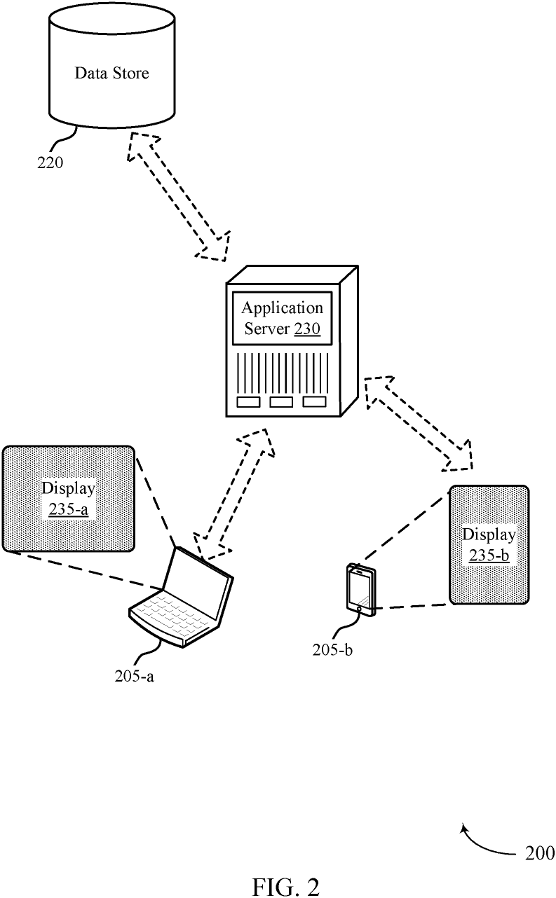

FIG. 2 illustrates an example of a system 200 that supports rule evaluation for related data metrics in real-time data stream in accordance with aspects of the present disclosure. The system 200 may include a number of user devices 205, which may be examples of cloud clients 105 or contacts 110 as described with reference to FIG. 1. The application server 230 may be examples of aspects of the cloud platform 115 and the data center 120 of FIG. 1. For example, the application server 230 may be represent various devices and components that support an analytical data system as described herein. The data store 220 may be an example of data center 120 of FIG. 1. The application server 230 may support a multi-tenant database system, which may manage various datasets that are associated with specific tenants (e.g., cloud clients 105).

A first user (e.g., an administrative user, a marketer, partner, etc.) may operate a first user device 205-a running an application that supports rule evaluation for real-time data stream. Using user device 205-a and the application, the first user may input a user input including a definition for one or more data metrics configured for a tenant in a multi-tenant system and one or more rules corresponding to an action a data stream. For example, the first user may input the instruction into a display 235-a associated with the first user device 205-a. As depicted herein, the rule evaluation may be displayed or accessed in different user interfaces. In some examples, the same application (e.g., supported by a single underlying metadata file or container) may be displayed differently on different user devices 205 corresponding to different user interface types. A user accessing an application or page on a user device 205-a (e.g., a laptop or desktop computer corresponding to a large form factor) may view a first display 235-a, while a user accessing the same application or page on a user device 205-b (e.g., a mobile phone corresponding to a small form factor) may view a second display 235-b. Thus, the user accessing an application or page on a user device 205 may view or otherwise interact with rule evaluation (evaluating one or more rules based on ingesting real-time data into a definition for generating an insight) via a display 235.

An application launcher at a user device 205 may indicate the applications or pages that are activated and available for the user device. In some cases, activating an application or page may push the application or page to a centralized system or server (e.g., an application server 230). Other user devices 205 may then access and display the activated application or page by interacting with the application server 230 (e.g., via an API). In some cases, when operating online, running an application or page at a user device 205 may involve a link between the user device 205 and the application server 230 storing information about the application or page (e.g., a display template). In other cases, when operating offline, the user device 205 may store the information about the application or page locally. In some examples, the user device 205 may initially download support for the application or page from the application server 230 before running the application or page without requiring further interactions with the application server 230.

According to one or more aspects of the present disclosure, a first user (e.g., an administrative user, a marketer, partner, etc.) operating the first user device 205-a may input a definition for an insight. In some examples, the system (e.g., application server 230) may import real-time data from data store 220. Data cloud streaming insights may help customers with low code/no code solutions to build real time use cases in minutes without requiring tedious development and integration work.

According to aspects depicted herein, the system 200 may support a pattern for real-time streaming and insights where the customer data platform or data cloud may curate business data and insights. These insights may be extremely useful not only within the data cloud but also in enabling scenarios that will ultimately be fulfilled outside of the customer data platform or data cloud. In the data cloud, data streams in the form of insights may be enriched with the related data from other data objects or insights.

As an example use case, in supply chain scenarios where temperature-sensitive goods are shipped (e.g., vaccine transportation), an IoT device may track the temperature of the shipping box but not the identifier of the shipment. If the shipment exceeds the safe temperature, customers may need to build logic that joins multiple tables to track shipment identifier that corresponds to the sensor reading. The tedious searching will increase the time to track the right container with the right device identifier will waste time and increase risk. This type of scenario can be simplified with rule evaluation for real-time data stream in accordance with aspects of the present disclosure.

As depicted herein, the system 200 may provide near real-time analytics and evaluating rule upon ingesting real-time data stream in a definition for one or more data metrics (e.g., data insights). Real-time (or near real-time) data analytics can drive powerful real time scenarios for customers. In some examples, use cases for real-time analytics may include too many login attempt from unusual locations, recent online customer behavior, unusual recent product transactions indicating fraud, credit card transactions anomaly detection, workflows based on recent information such as train delay. In some examples, data cloud may enable a broad set of analytical as well as machine learning functions to be able to drive highly valuable real-time insights. The data cloud (hosted by application server 230) may continuously read and process streaming data from the data store 220 (including profile objects in real time). The application server 230 may utilize the techniques depicted herein to express insights using an insights builder. The insights may be used to process the incoming streaming data, generate metrics to produce the output. Customers can calculate metrics over the time windows, and then stream values to other platforms or data sources with corresponding actions. Additionally, or alternatively, the insights calculated according to the techniques of the present disclosure may include a reference to another calculated insight.

In some examples, the application server 230 may be configured to send the output via data action to a number of destinations. One or more aspects of the present disclosure support a number of techniques for enriching the insight generation using nested queries. Additionally, or alternatively, the techniques depicted herein support various windowing schemes to enable time series analysis on data metrics.

To calculate an insight, the system 200 may support a storage application for streaming insights (implemented on top of a current storage application framework for batch insights), an orchestration component and stream processing. The orchestration component of an existing batch calculated insight engine may be extended to support streaming and actioning. For orchestration, the workflow phases may be triggered by pushing messages to a single workflow queue. By default, the workflow may be initiated by a tenant schedule (different and more frequent than the one used by batch workflow). The system 200 may handle concurrent workflows. In some examples, a single job for metrics (or rules) may be initiated per tenant containing multiple stream queries, one for each insight (or definition). To support stream processing, the system 200 may include receiving an input, processing metric and action storage. In some examples, mobile software development kit or web events coming through one or more data pipeline topic(s) may serve as the stream sources for generating insight metrics. Batch data (profile and potentially other data objects including batch insights) may be joined with event streams while generating metrics. Stream inputs for rule processing may be the insight metrics from insight stream jobs streamed through intermediate database tables. in some examples, the profile data may be used to enrich actions during rule evaluation.

To support calculating insights using other insights, the system 200 may support query language validation changes within a data server. The system 200 may check whether a query is a data object or a sub-query. If it is not a data object or a sub-query, then the system 200 may categorize it as an existing insight. For an existing insight, the system 200 may verify that a corresponding field exists with a correct type. For a database job, the system 200 may compute non-metrics on metrics calculate insights (first-level calculated insights) and store the results without triggering any ingestion work. The system 200 may then compute metrics on metrics (second-level calculated insights) based on data object and the first-level calculated insights. Additionally, or alternatively, the system 200 may generate a query to compute external measure values based on internal measure values. When calculating the first-level calculated insights, the system 200 may store external measures as internal measures. If the second-level calculated insights is based on an external measure value of the first-level calculated insights, then the system 200 may generate a query to compute the external measure value first. In some examples, the system 200 may provide enhancements to database server graph generation for processing of metrics on metrics to support displaying the correct calculated insights within a user interface. The application server 230 may support a new metadata flag suggesting that the calculated insight is made of or otherwise include a reference to other calculated insights. The application server 230 may review other calculated insights to determine which data objects are related and build the edges on that.

In some examples, the system 200 may provide support for one or more child calculated insights within a parent calculated insight. A child calculated insight may be considered to be any calculated insight referenced within a query statement of another calculated insight. A parent calculated insight may be considered to be any calculated insight that references a child calculated insight within its query statement. The system 200 may create an N level deep parent/child relationship of calculated insights. For example, calculated insight 3 may have child calculated insight 2 and calculated insight 2 may have child calculated insight 1. In some examples, the system 200 may enforce a configurable limit on the number of hierarchical levels supported (a limit of 3).

Additionally, or alternatively, the system 200 may measure within a “SELECT” clause referencing a child calculated insight measure may adhere to a common rollupable threshold. If a child calculated insight with measure marked as rollupable, then an aggregation function may be applied to the measure If a child calculated insight with a measure marked as non-rollupable, then an aggregation is not required. If the “SELECT” clause references a child calculated insight measure that is non-rollupable, then all dimensions for the child calculated insight may be referenced in the “SELECT” clause, or an “ON” clause, or a “WHERE” clause. In some cases, the “ON” clause or “WHERE” clause references may use an equality operator. In some examples, the system 200 may support for child calculated insight which are external insights. In some examples, the system 200 may enforce a constraint when a user attempts to “DELETE” or “DISABLE” a calculated insight throwing an exception if the calculated insight is a child of another active calculated insight. This may be handled by a core. In some cases, a calculated insight to data object relationship may be used by a database server graph generation to highlight the correct calculated insights within a user interface.

To support expanded querying functionalities, the system 200 may support we query validation changes within a database server and one or more calculation changes. In some examples, the calculation changes may include a scheduler change to generate a database availability group as part of a database job configuration and a job change to compute calculated insight on calculated insight by the database availability group. The following example describes a first calculated insight (CI1), a second calculated insight (CI2) and constructed query.

For CI1:
CI Name - EmailClickRate_cio
Measures - ClickRate_c
Dimensions - IndividualId_c & EmailType_c
DLOs - Individual_dlm, EmailEvent_dlm

For CI2:
CI Name - EmailOpenRate_cio
Measures - OpenRate_c
Dimensions - IndividualId_c & EmailType_c
DLOs - Individual_dlm, EmailEvent_dlm

Constructed Query:
SELECT
SUM(EmailClickRate_cio.ClickRate_c) as TotalClickRate_c,
SUM(EmailOpenRate_cio.OpenRate_c) as TotalOpenRate_c,
SUM(SalesOrder_dlm.OrderAmount_c) as TotalOrderAmount_c,
SalesOrder_dlm.OrderType_c as OrderType_c,
EmailOpenRate_cio.IndividualId_c as IndividualId_c,
EmailOpenRate_cio.EmailType_c as EmailType_c,
FROM
EmailOpenRate_cio
JOIN EmailClickRate_cio
ON EmailOpenRate_cio.IndividualId_c = EmailClickRate_cio.IndividualId_c
JOIN SalesOrder_dlm
ON EmailOpenRate_cio.IndividualId_c = SalesOrder_dlm.PartyId_c
GROUP BY
EmailOpenRate_cio.IndividualId_c,
EmailOpenRate_cio.EmailType_c,
SalesOrder_dlm.OrderType_c

To support API changes for calculated insights management, the system 200 may support changes to create or update API (e.g., edit display name and description on calculated insights, edit display name and description on calculated insight dimensions and measures, and create a calculated insight in draft mode and transition it to non-draft mode). Additionally, or alternatively, the system 200 may provide a technique to enable or disable a calculated insight API, and a technique to provide a bulk query statement validation API and a list of supported functions API. In some examples, the system 200 may support changes to the computation orchestration to not process disabled and draft mode calculated insights. In some examples, a database schema for the metadata of a calculated insight is as follows:

(
id UUID NOT NULL DEFAULT Uuid_generate_v4(),
name VARCHAR(255) NOT NULL,
version BIGINT,
label VARCHAR(255), // 232: New column
description VARCHAR,
tenant_id VARCHAR(255) NOT NULL,
created by VARCHAR(255) NOT NULL,
created date TIMESTAMP NOT NULL DEFAULT timezone('UTC',
now()),
is active BOOLEAN NOT NULL DEFAULT false,
is_draft_mode BOOLEAN NOT NULL DEFAULT false, // 232: New column
provisioning_status VARCHAR(255) NOT NULL,
modified_by VARCHAR(255) NOT NULL,
modified date TIMESTAMP NOT NULL DEFAULT timezone('UTC',
now()),
definition JSONB NOT NULL,
dynamic_schema_id BIGINT NOT NULL,
dynamic_schema_name VARCHAR(255) NOT NULL,
tenant_timezone_id VARCHAR(100) NOT NULL DEFAULT 'UTC',
PRIMARY KEY(tenant_id, id)
);

According to one or more aspects, the system 200 may support arithmetic operations. In some cases, a measure may be identified by aggregation functions and window functions, where selected attribute satisfies one of the following, it may be considered a measure: (1) includes aggregation functions (count/sum/min/max/avg/mean/last/first/percentile) or (2) includes window functions (rank/dense_rank/percent_rank/row_number/last_value/first_value/lead/lag). Otherwise, the selected attributes may be considered as dimensions and may appear in group by list. In some examples, measures including simple rollupable aggregations may be considered rollupable measures. The simple rollupable aggregations may include one or more of count, sum, minimum, maximum, average or mean, last, and first. In some instances, expressions including the rollupable aggregations only, may also be considered rollupable. For example, Count(Table.Field) * 100 or Count(Table.Field1)/Count(Table.Field2). To query a rollupable measure, a user call a parse API provided on a metadata service, which will translate calculated insight attribute names to actual column names to be queried in a storage. If multiple dimensions are defined, the user can choose to only query measures with a subset of dimensions, the result may be rolled up based on measure definition. For example, if the user inputs Definition of “measure1_c” is “Count(Table.Field)”, then the expression “Sum(measure1_c)” may be used to query the storage layer to get a proper rollup result. Similarly, of the user input “Definition of “measure1_c” is “Count(Table.Field) + 100”, then the expression “Sum(measure1_c) + 100” may be used to query the storage layer to get a proper rollup result. In both scenarios above, group by section in query response may be populated by a list of requested dimensions.

In some examples, expressions containing non-rollupable aggregations/functions, are considered non-rollupable. For example, an expression “Percentile(Table.Field1) * Sum(Table.Field2) -> non-rollupable” as percentile is non-rollupable. To query a non-rollupable measure, the user may call the same parse API, but all defined dimensions may be present in the request. Measure expression may be included as a column node for simple select.

According to one or more aspects, a nested/sub/inner queries may be parsed into separate calculated insights and stored as dependencies of main calculated insight. The definitions and results of sub calculated insights are only available in the scope of the main calculated insights, and cannot be referenced directly in another calculated insights definition. In some examples, computing calculated insights with dependencies may be performed by an insights engine. The insights engine may collect metadata, generate a query script and submit jobs. In some examples, the query supports each dependency as a temporary table. The insights engine then uses the temporary table result to calculate the main calculated insight by calculating the dependencies in referencing order (where multiple dependencies are supported with the same alias).

In some examples, the system 200 may provide for alerting (an action) and alert event delivery design (action delivery design) using the eventing infrastructure. Aspects depicted herein, in addition to calculating insights using real-time data stream, the system 200 may provide for enabling change data capture and alert or action event delivery. In some examples, the system 200 may support control events for data stream, segmentation and activation status changes. All control events may be available for consumption from core as record level events on the representational entities using which end users can build flows and apex triggers. Once the insights are generated for real-time data stream, the calculated insight streaming alerts may be (a) represented, (b) produced and (c) delivered for the end user consumption.

One of the main use cases for a change data capture may be that a customer copies and synchronizes the entire unified customer profile information in their custom implemented downstream external systems. In such cases, these systems may need to know as soon as some profile information is modified (e.g., email address or contact phone number of a customer is changed) as the customer’s business process flows depend on the real time update. The sheer volume of profile and engagement data may add a lot of complexity to the eventing system. Also in a big data system, the data manipulation (ingestion, aggregate computation) typically happens from various data pipelines (streams, API, micro batches and batches) and there is no one common layer that handles the data changes from different pipes. In some examples, the calculated insights may be used to define and calculate multidimensional metrics from an entire digital state stored in a customer data platform. The metrics for the definition (e.g., insights) can include customer lifetime value, most viewed categories, and customer satisfaction score at the profile, segment, population level, or any other metrics. Marketers can use calculated insights to define segment criteria and personalization attributes for activation using metrics, dimensions, and filters.

As depicted herein, the system 200 may receive one or more rules corresponding to an action. The system 200 may evaluate the one or more rules based on ingesting a real-time data stream into a definition for one or more data metrics. For example, the system 200 may evaluate the one or more rules based on calculating an insight using the real-time data stream. In some examples, the application server 230 may receive a second user input via the first user device 205-a or the second user device 205-b. The second user input may include a selection of a target for the action, where triggering the action may include triggering the action at the target.

To generate an alert, the system 200 may use metadata including alert definition, filter definition, and subscription definition. The system 200 may further use an event schema (representation and discovery) and an alert delivery structure. In some examples, all the metadata related to the actions may be persisted in core and synced to off-core. The system 200 may use a metadata service database (e.g., data store 220) as an alert database. In some examples, the system 200 may use application programming interfaces (APIs) to define one or rules associated with an alert or an action. The system 200 may use an alert orchestrator for managing one or more streaming jobs required for filter evaluation of the streamed computed data. In some examples, the system 200 may also support an event service which is responsible for draining the events from data pipelines and delivering it to the core.

In some examples, a customer may define the alerts in core (included in application server 230) which may then get synced to off-core via an existing asynchronization design pattern. Deleting these objects from core may delete it from off-core (with message queue delay). Additionally, or alternatively, disabling these objects from core may disable it from off-core and it may not be processed further by the alert orchestrator. In some examples, alert and alert target may be defined independently, where alert filter and payload are defined as part of an alert. In some examples, an alert filter can span multiple tables and hence filters are independent rows that can be queried. In some examples, alert target configuration may contain any additional authentication details needed for a target. For target type core, the event object may be pre-defined and no additional details may be needed from the customer. In some examples, a composite key (e.g., developer name + tenant identifier) may be used as a package for alert and an alert target. if a relationship is not established explicitly between an alert filter condition and an alert payload, then the application server 230 may maintain the referential integrity between the alert and the alert target and the corresponding insight. In some examples, alerts may include a post alert (or a post action), a get alert, and a delete alert and their corresponding targets.

In some examples, calculated insights may be used to trigger email sends. For instance, a retailer may send customers an email with a “How To Video” and “Install Instructions” if they purchase an item requiring complex installation and searched for “Install Manual on Website” in the last 5 minutes. Additionally, or alternatively, an application server may trigger an email send from real-time streaming engagement objects. For example, a software may send a confirmation email when a user completes an action (e.g., completes a training). The calculated insights may be used to trigger an alert for a user to complete an application (e.g., a quote application). In some instances, the calculated insights may also trigger predefined actions (e.g., a customer checks into hotel, the calculated insights may trigger them into journey to prompt them to visit the hotel bar or check out luxury vacations and activities).

Thus, the aspects depicted herein provide for powerful real-time processing of business critical data, support thousands of data sources with millisecond latency, and enable powerful workflows. In addition, near real-time insights may be performed at petabyte scale on entire digital state stored in the data cloud. With its vast array of logical, math, statistical and times series functions and support for the complex workflow aspects depicted herein may be utilized to calculate any kind of metrics or insights.

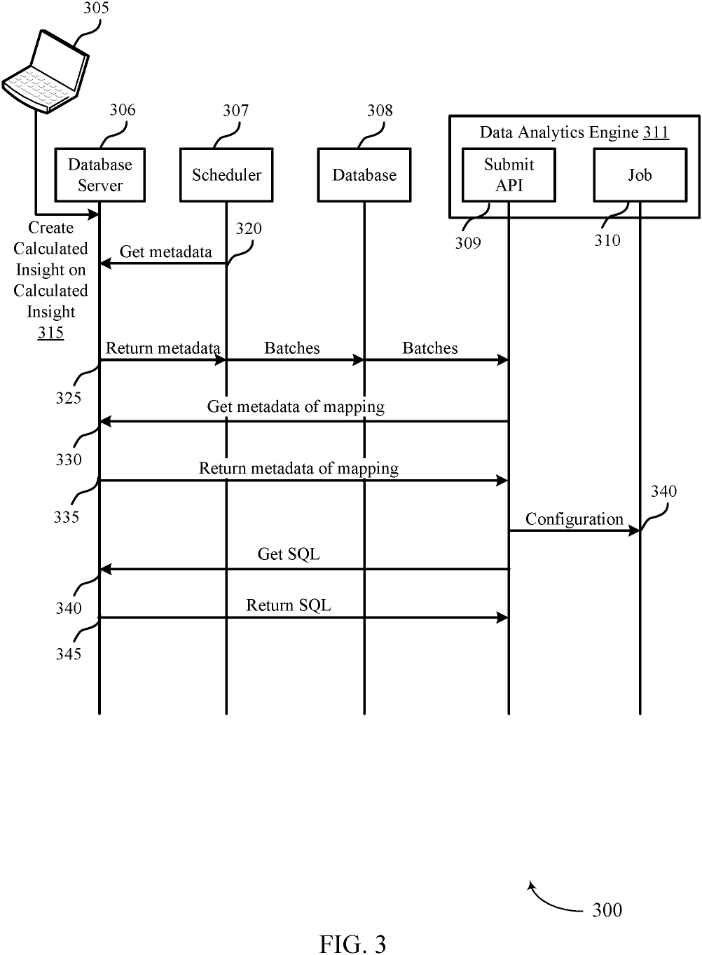

FIG. 3 illustrates an example of a process flow 300 that supports rule evaluation for related data metrics in real-time data stream in accordance with aspects of the present disclosure. The process flow 300 may be implemented by an application server and a data store. The process flow 300 may support generating insights (e.g., definitions) from a real-time stream of data. the streaming insights feature may enable customers to generate metrics and actions from cross-functional stream data in near real time. A customer or user may define insight computations where a calculated insight refers to another calculated insight.

In the example of FIG. 3, the application server may receive a request 315 to create a second calculated insight (CI2) from a first calculated insight (CI1). The application server may receive the request 315 from a user device 305. If CI2 is built based on CI1, then CI1 is referred to as child CI of CI2, and CI2 as parent CI of CI1. Calculation of CI computation may refer to an analytics computation and materialization of CI may refer to both analytics computation and data ingestion. Each CI node may include the following fields:

|CiNode
| name
| islandId // positive integer, island current CI belongs to
| level // positive integer, level within an island (no maximal limit)
| referenceCount // the number of CIs that depend on current CI
| isMaterializationNeeded // Boolean
| List<CiNode> parents
| List<CiNode> children

The example of FIG. 3 begins with a user via user device 305 creating a calculated insight on calculated insight via request 315. Upon receiving the user input, at 320, a database server 306 may receive metadata of the calculated insights from a scheduler 307. At 325, the database server 306 may also return metadata of the calculated insights to the scheduler 307. The scheduler 307 in turn transmits batches of data to a database 308 and a data analytics engine 311 including a submit API 309 and a job 310. In some examples, the scheduler 307 may build the batches of data. At 330, the scheduler 307 may receive metadata of mapping and at 335, the scheduler 307 may return the metadata of mapping. In some examples, the submit API 309 may transmit a configuration to the job 310, at 340. For each CI, the scheduler 307 may generate a new CiNode with the current name if it doesn’t exist, or skip it. Once CiNode is generated, the scheduler 307 may check if the current CI has a dependency on any child CI. If not, the scheduler 307 may set its level = 1. Else, the scheduler 307 may recursively check and generate CiNode for these child CIs. Once all child CiNodes are generated, the scheduler 307 may set current CiNode.level = max(child CI level) + 1. The scheduler 307 may also set parents and children for each CiNodes during visiting. The reference count of a child CI is increased when the scheduler visits it from its parent CI. In some examples, the scheduler 307 may travel from a CiNode, and mark all CiNodes it finds with the same identifier. Once the scheduler 307 knows the level and island id of every CI, the scheduler 307 generates CI batches within the same group (having same identifier). For CI with level = N, the scheduler 307 may put the CIs in the Nth batch. In the above example for island2, the 1st batch is {CI2, CI3}, the 2nd batch is {CI4, CI5} and the 3rd batch is {CI6}. For island1, there is only 1 batch {CI1}.

In some examples, CI1 may be created earlier than CI2. When CI2 is created, CI1 may have just succeeded finishing a run. By existing filter logic, the scheduler 307 may not include CI1 with the run of CI2. This may end with a result that both CI1 and CI2’s latest run succeed but their data is not consistent and CI1’s data is older than CI2. Binding CI1 and CI2 may make their data consistent. In another example, CI1 is created a bit earlier than CI2. When CI2 is created, CI1 is skipped because it just successfully finished a run. By existing filter logic, the scheduler may not include CI1 with the run of CI2. If they are not bound together for now, they likely may not be bound together in future schedules. For instance, within 24 hours, the scheduler 307 may calculate CI1 and CI2 in 2 schedules. Because CI2’s calculation involves CI1’s calculation, the scheduler may calculate CI1 twice. By binding CI1 and CI2 in a single schedule, re-computation is avoided. As depicted in the example of FIG. 3, the data analytics engine 311 returns a query translate internal measures, at 345, and receives a query to translate the internal measures, at 350.

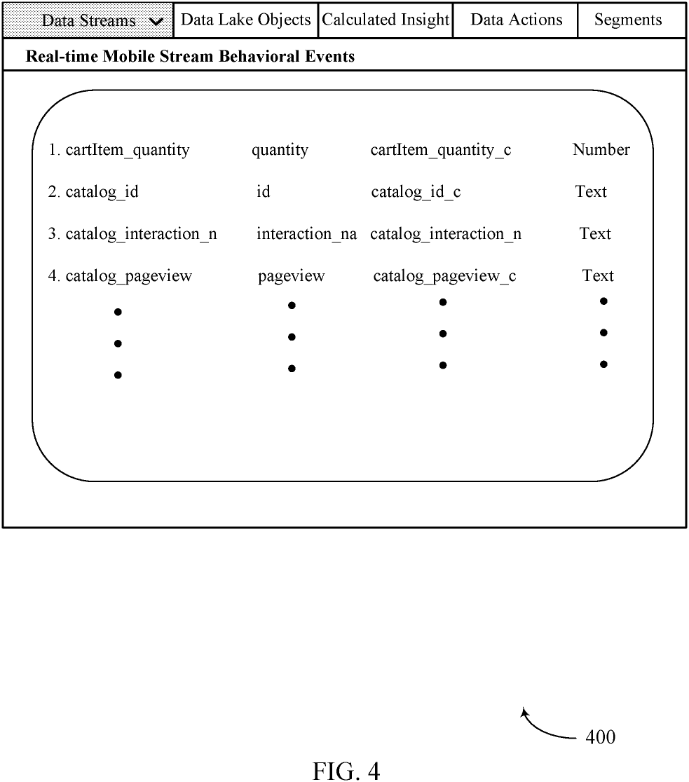

FIG. 4 illustrates an example of a user interface 400 that supports rule evaluation for related data metrics in real-time data stream in accordance with aspects of the present disclosure. The user interface 400 may be an example of an interface that supports generation of insights (or definitions) based on receiving a real-time data stream, and the user interface 400 may be supported by aspects of FIG. 1, such as cloud platform 115. As illustrated, the user interface 400 displays a real-time data stream for a particular tenant (e.g., cloud client 105). The user interface 400 also displays a tab name calculated insights. The calculated insights tab enable a user to input a definition for one or more data metrics to be used by the system (application server) to generate an insight for a real-time data stream. As depicted in the example of FIG. 4, the real-time mobile stream behavioral events depict different data metrics for different aspects of a real-time data stream. A user may define one or more insights and alerts based on the real-time mobile stream behavioral events.

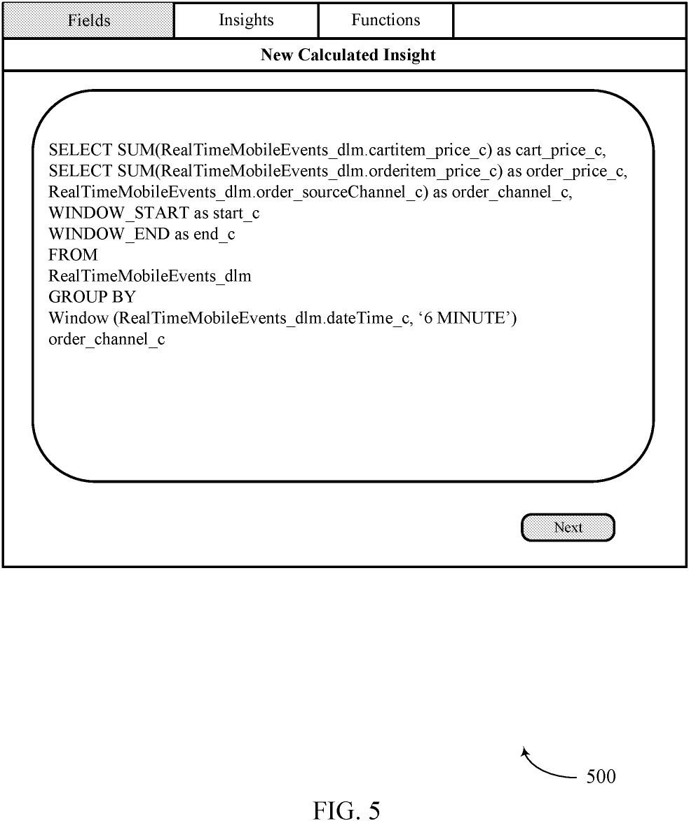

FIG. 5 illustrates an example of a user interface 500 that supports rule evaluation for related data metrics in real-time data stream in accordance with aspects of the present disclosure. The user interface 500 may be an example of an interface that supports calculating insights (or definitions) based on receiving a real-time data stream, and the user interface 500 may be supported by aspects of FIG. 1, such as cloud platform 115. As illustrated, the user interface 500 displays a calculated insight for a real-time data stream captured for a time period. As depicted herein, the system supporting the user interface 500 may receive a user input including a definition for one or more data metrics configured for a tenant in a multi-tenant system and one or more rules corresponding to an action. The system may then receive a real-time data stream associated with the tenant in the multi-tenant system (as depicted with reference to FIG. 4). The user interface 500 may support ingesting the real-time data stream into the definition for the one or more data metrics. That is, the calculated insight is based on ingesting the real-time data stream into the definition for the one or more data metrics

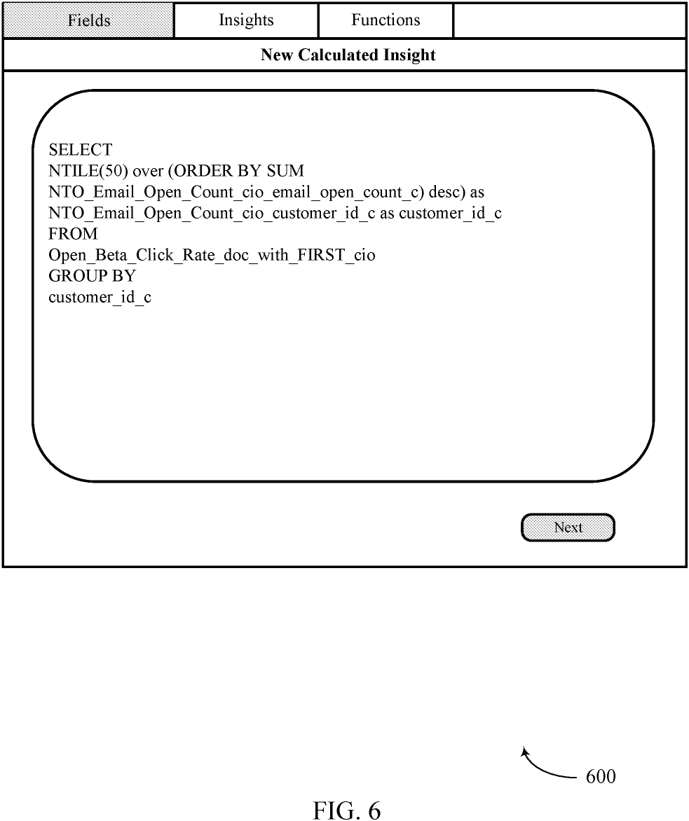

FIG. 6 illustrates an example of a user interface 600 that supports rule evaluation for related data metrics in real-time data stream in accordance with aspects of the present disclosure. The user interface 600 may be an example of an interface that supports reference to another insight when calculating an insight (or definition), and the user interface 600 may be supported by aspects of FIG. 1, such as cloud platform 115. As depicted with reference to FIGS. 4 and 5, an insight may be generated based on ingesting a real-time data stream into a definition for one or more data metrics. A system supporting the user interface 600 may receive, via a user interface, a first user input include a first definition for a first set of data metrics configured for a tenant in a multi-tenant system. The system may also receive, via the user interface, a second user input including a second definition for a second set of data metrics configured for the tenant in the multi-tenant system. In some examples, the system may receive a real-time data stream associated with the tenant in the multi-tenant system and evaluates, in a batch manner, one or more rules based on ingesting the real-time data stream into the first definition for the first set of data metrics and the second definition for the second set of data metrics. As depicted in the example of FIG. 6, the calculate insight refers to another insight “Open_Rate_Click_Rate_doc_with_FIRST_cio” retrieved from a list of insights. In some examples, the system may trigger the action based on evaluating the one or more rules.

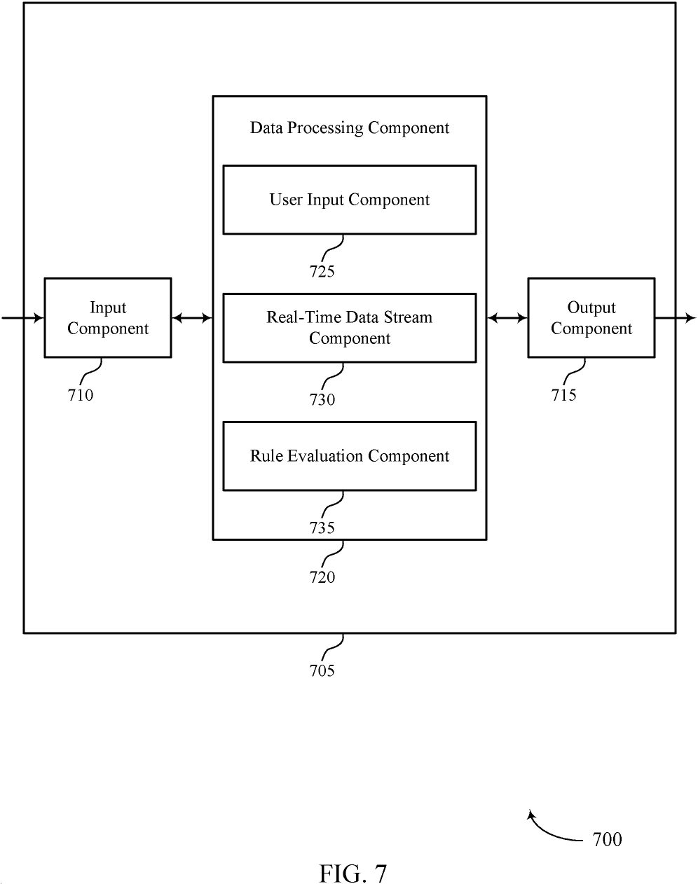

FIG. 7 shows a block diagram 700 of a device 705 that supports rule evaluation for related data metrics in real-time data stream in accordance with aspects of the present disclosure. The device 705 may include an input component 710, an output component 715, and a data processing component 720. The device 705 may also include a processor. Each of these components may be in communication with one another (e.g., via one or more buses).

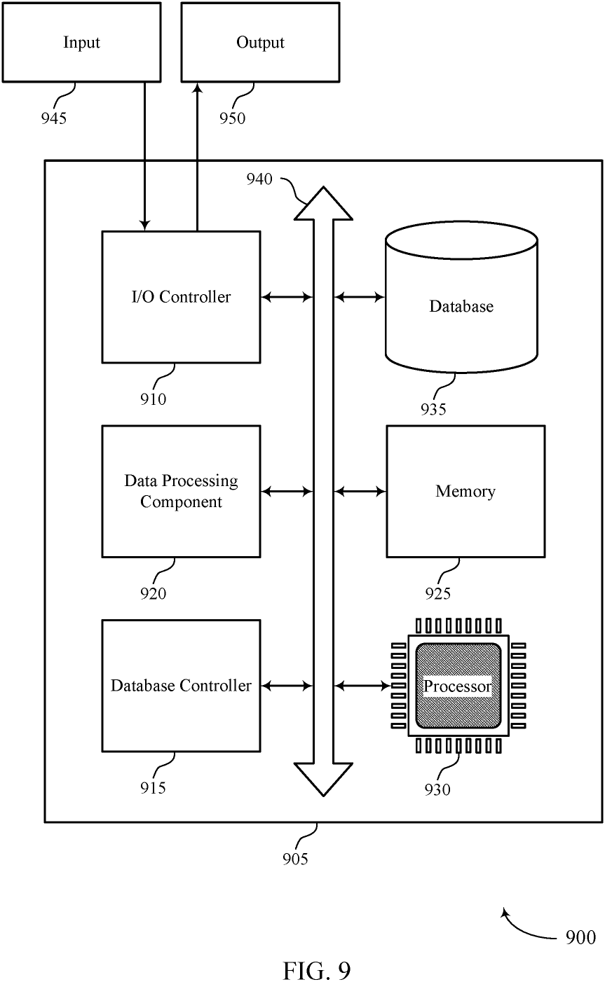

The input component 710 may manage input signals for the device 705. For example, the input component 710 may identify input signals based on an interaction with a modem, a keyboard, a mouse, a touchscreen, or a similar device. These input signals may be associated with user input or processing at other components or devices. In some cases, the input component 710 may utilize an operating system such as iOS®, ANDROID®, MS-DOS®, MS-WINDOWS®, OS/2®, UNIX®, LINUX®, or another known operating system to handle input signals. The input component 710 may send aspects of these input signals to other components of the device 705 for processing. For example, the input component 710 may transmit input signals to the data processing component 720 to support rule evaluation for related data metrics in real-time data stream. In some cases, the input component 710 may be a component of an I/O controller 910 as described with reference to FIG. 9.

The output component 715 may manage output signals for the device 705. For example, the output component 715 may receive signals from other components of the device 705, such as the data processing component 720, and may transmit these signals to other components or devices. In some examples, the output component 715 may transmit output signals for display in a user interface, for storage in a database or data store, for further processing at a server or server cluster, or for any other processes at any number of devices or systems. In some cases, the output component 715 may be a component of an I/O controller 910 as described with reference to FIG. 9.

For example, the data processing component 720 may include a user input component 725, a real-time data stream component 730, a rule evaluation component 735, or any combination thereof. In some examples, the data processing component 720, or various components thereof, may be configured to perform various operations (e.g., receiving, monitoring, transmitting) using or otherwise in cooperation with the input component 710, the output component 715, or both. For example, the data processing component 720 may receive information from the input component 710, send information to the output component 715, or be integrated in combination with the input component 710, the output component 715, or both to receive information, transmit information, or perform various other operations as described herein.

The data processing component 720 may support data processing at an application server in accordance with examples as disclosed herein. The user input component 725 may be configured to support receiving, via a user interface, a first user input comprising a first definition for a first set of data metrics configured for a tenant in a multi-tenant system. The user input component 725 may be configured to support receiving, via the user interface, a second user input comprising a second definition for a second set of data metrics configured for the tenant in the multi-tenant system. The real-time data stream component 730 may be configured to support receiving a real-time data stream associated with the tenant in the multi-tenant system. The rule evaluation component 735 may be configured to support evaluating, in a batch manner, one or more rules based at least in part on ingesting the real-time data stream into the first definition for the first set of data metrics and the second definition for the second set of data metrics.

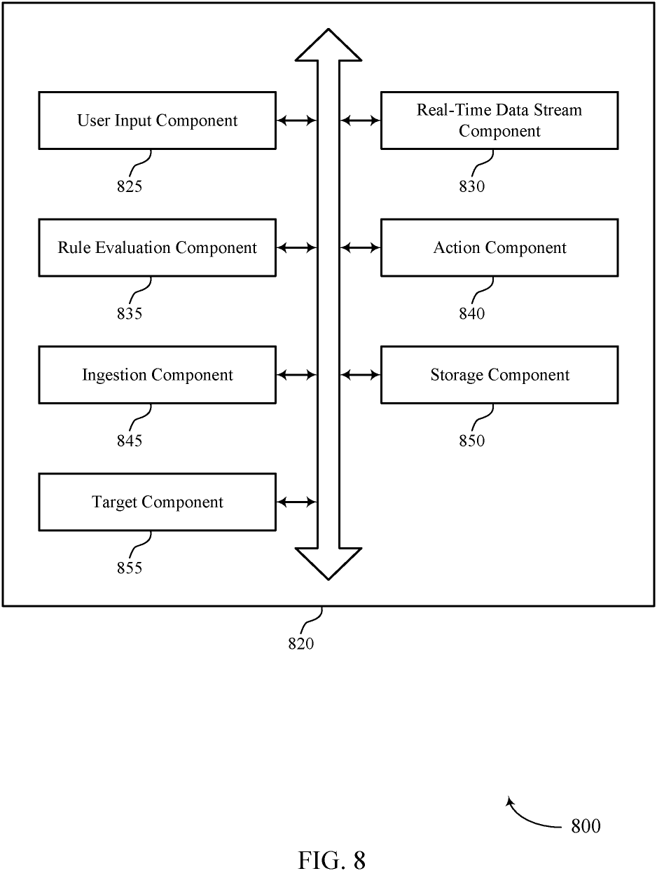

FIG. 8 shows a block diagram 800 of a data processing component 820 that supports rule evaluation for related data metrics in real-time data stream in accordance with aspects of the present disclosure. The data processing component 820 may be an example of aspects of a data processing component or a data processing component 720, or both, as described herein. The data processing component 820, or various components thereof, may support performing various aspects of rule evaluation for related data metrics in real-time data stream as described herein. For example, the data processing component 820 may include a user input component 825, a real-time data stream component 830, a rule evaluation component 835, an action component 840, an ingestion component 845, a storage component 850, a target component 855, or any combination thereof. Each of these components may communicate, directly or indirectly, with one another (e.g., via one or more buses).

The data processing component 820 may support data processing at an application server in accordance with examples as disclosed herein. The user input component 825 may be configured to support receiving, via a user interface, a first user input comprising a first definition for a first set of data metrics configured for a tenant in a multi-tenant system. In some examples, the user input component 825 may be configured to support receiving, via the user interface, a second user input comprising a second definition for a second set of data metrics configured for the tenant in the multi-tenant system. The real-time data stream component 830 may be configured to support receiving a real-time data stream associated with the tenant in the multi-tenant system. The rule evaluation component 835 may be configured to support evaluating, in a batch manner, one or more rules based at least in part on ingesting the real-time data stream into the first definition for the first set of data metrics and the second definition for the second set of data metrics.

In some examples, the action component 840 may be configured to support receiving, via the user interface, one or more rules corresponding to an action. In some examples, the action component 840 may be configured to support triggering the action based at least in part on evaluating the one or more rules in the batch manner.

In some examples, the target component 855 may be configured to support receiving, via the user interface, a selection of a target for the action, wherein triggering the action comprises triggering the action at the target. In some examples, the rule evaluation component 835 may be configured to support determining that the second definition for the second set of data metrics includes a reference to the first definition for the first set of data metrics, wherein evaluating the one or more rules is based at least in part on the determining. In some examples, the rule evaluation component 835 may be configured to support receiving, via the user interface, one or more rules corresponding to an action, and triggering the action on a set of action destinations based on the one or more rules.

In some examples, the ingestion component 845 may be configured to support inputting, via an ingestion engine, the real-time data stream into the first definition for the first set of data metrics and the second definition for the second set of data metrics. In some examples, the storage component 850 may be configured to support storing the real-time data stream associated with the tenant in the multi-tenant system in a cache memory.

FIG. 9 shows a diagram of a system 900 including a device 905 that supports rule evaluation for related data metrics in real-time data stream in accordance with aspects of the present disclosure. The device 905 may be an example of or include the components of a device 705 as described herein. The device 905 may include components for bi-directional data communications including components for transmitting and receiving communications, such as a data processing component 920, an I/O controller 910, a database controller 915, a memory 925, a processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. In other cases, the I/O controller 910 may represent or interact with a modem, a keyboard, a mouse, a touchscreen, or a similar device. In some cases, the I/O controller 910 may be implemented as part of a processor 930. In some examples, a user may interact with the device 905 via the I/O controller 910 or via hardware components controlled by the I/O controller 910.

The database controller 915 may manage data storage and processing in a database 935. In some cases, a user may interact with the database controller 915. In other cases, the database controller 915 may operate automatically without user interaction. The database 935 may be an example of a single database, a distributed database, multiple distributed databases, a data store, a data lake, or an emergency backup database.

Memory 925 may include random-access memory (RAM) and ROM. The memory 925 may store computer-readable, computer-executable software including instructions that, when executed, cause the processor 930 to perform various functions described herein. In some cases, the memory 925 may contain, among other things, a BIOS which may control basic hardware or software operation such as the interaction with peripheral components or devices.

The processor 930 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 930 may be configured to operate a memory array using a memory controller. In other cases, a memory controller may be integrated into the processor 930. The processor 930 may be configured to execute computer-readable instructions stored in a memory 925 to perform various functions (e.g., functions or tasks supporting rule evaluation for related data metrics in real-time data stream).

The data processing component 920 may support data processing at an application server in accordance with examples as disclosed herein. For example, the data processing component 920 may be configured to support receiving, via a user interface, a first user input comprising a first definition for a first set of data metrics configured for a tenant in a multi-tenant system. The data processing component 920 may be configured to support receiving, via the user interface, a second user input comprising a second definition for a second set of data metrics configured for the tenant in the multi-tenant system. The data processing component 920 may be configured to support receiving a real-time data stream associated with the tenant in the multi-tenant system. The data processing component 920 may be configured to support evaluating, in a batch manner, one or more rules based at least in part on ingesting the real-time data stream into the first definition for the first set of data metrics and the second definition for the second set of data metrics.

By including or configuring the data processing component 920 in accordance with examples as described herein, the device 905 may support techniques for, improved user experience.

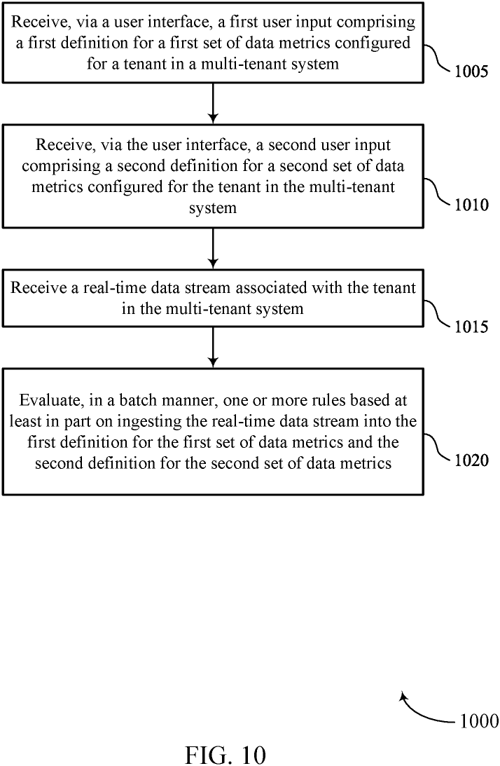

FIG. 10 shows a flowchart illustrating a method 1000 that supports rule evaluation for related data metrics in real-time data stream in accordance with aspects of the present disclosure. The operations of the method 1000 may be implemented by an application server or its components as described herein. For example, the operations of the method 1000 may be performed by an application server as described with reference to FIGS. 1 through 9. In some examples, an application server may execute a set of instructions to control the functional elements of the application server to perform the described functions. Additionally, or alternatively, the application server may perform aspects of the described functions using special-purpose hardware.

At 1005, the method may include receiving, via a user interface, a first user input comprising a first definition for a first set of data metrics configured for a tenant in a multi-tenant system. The operations of 1005 may be performed in accordance with examples as disclosed herein. In some examples, aspects of the operations of 1005 may be performed by a user input component 825 as described with reference to FIG. 8.

At 1010, the method may include receiving, via the user interface, a second user input comprising a second definition for a second set of data metrics configured for the tenant in the multi-tenant system. The operations of 1010 may be performed in accordance with examples as disclosed herein. In some examples, aspects of the operations of 1010 may be performed by a user input component 825 as described with reference to FIG. 8.

At 1015, the method may include receiving a real-time data stream associated with the tenant in the multi-tenant system. The operations of 1015 may be performed in accordance with examples as disclosed herein. In some examples, aspects of the operations of 1015 may be performed by a real-time data stream component 830 as described with reference to FIG. 8.

At 1020, the method may include evaluating, in a batch manner, one or more rules based at least in part on ingesting the real-time data stream into the first definition for the first set of data metrics and the second definition for the second set of data metrics. The operations of 1020 may be performed in accordance with examples as disclosed herein. In some examples, aspects of the operations of 1020 may be performed by a rule evaluation component 835 as described with reference to FIG. 8.

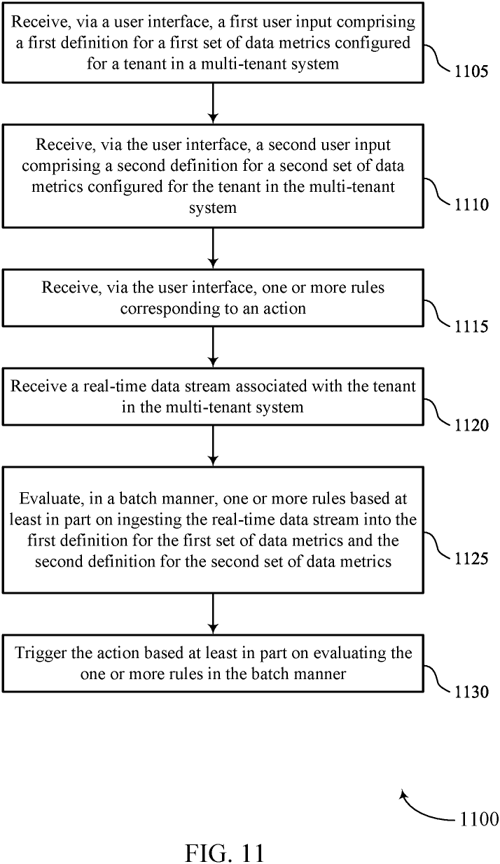

FIG. 11 shows a flowchart illustrating a method 1100 that supports rule evaluation for related data metrics in real-time data stream in accordance with aspects of the present disclosure. The operations of the method 1100 may be implemented by an application server or its components as described herein. For example, the operations of the method 1100 may be performed by an application server as described with reference to FIGS. 1 through 9. In some examples, an application server may execute a set of instructions to control the functional elements of the application server to perform the described functions. Additionally, or alternatively, the application server may perform aspects of the described functions using special-purpose hardware.

At 1105, the method may include receiving, via a user interface, a first user input comprising a first definition for a first set of data metrics configured for a tenant in a multi-tenant system. The operations of 1105 may be performed in accordance with examples as disclosed herein. In some examples, aspects of the operations of 1105 may be performed by a user input component 825 as described with reference to FIG. 8.

At 1110, the method may include receiving, via the user interface, a second user input comprising a second definition for a second set of data metrics configured for the tenant in the multi-tenant system. The operations of 1110 may be performed in accordance with examples as disclosed herein. In some examples, aspects of the operations of 1110 may be performed by a user input component 825 as described with reference to FIG. 8.

At 1115, the method may include receiving, via the user interface, one or more rules corresponding to an action. The operations of 1115 may be performed in accordance with examples as disclosed herein. In some examples, aspects of the operations of 1115 may be performed by an action component 840 as described with reference to FIG. 8.

At 1120, the method may include receiving a real-time data stream associated with the tenant in the multi-tenant system. The operations of 1120 may be performed in accordance with examples as disclosed herein. In some examples, aspects of the operations of 1120 may be performed by a real-time data stream component 830 as described with reference to FIG. 8.

At 1125, the method may include evaluating, in a batch manner, one or more rules based at least in part on ingesting the real-time data stream into the first definition for the first set of data metrics and the second definition for the second set of data metrics. The operations of 1125 may be performed in accordance with examples as disclosed herein. In some examples, aspects of the operations of 1125 may be performed by a rule evaluation component 835 as described with reference to FIG. 8.

At 1130, the method may include triggering the action based at least in part on evaluating the one or more rules in the batch manner. The operations of 1130 may be performed in accordance with examples as disclosed herein. In some examples, aspects of the operations of 1130 may be performed by an action component 840 as described with reference to FIG. 8.

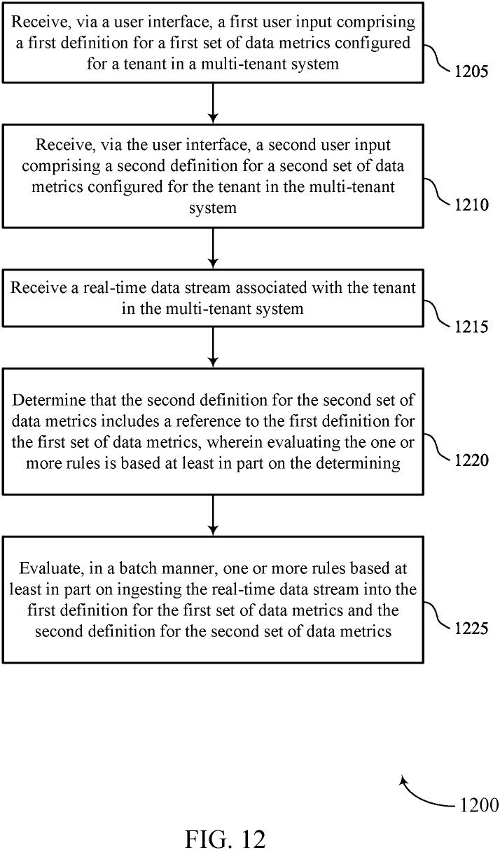

FIG. 12 shows a flowchart illustrating a method 1200 that supports rule evaluation for related data metrics in real-time data stream in accordance with aspects of the present disclosure. The operations of the method 1200 may be implemented by an application server or its components as described herein. For example, the operations of the method 1200 may be performed by an application server as described with reference to FIGS. 1 through 9. In some examples, an application server may execute a set of instructions to control the functional elements of the application server to perform the described functions. Additionally, or alternatively, the application server may perform aspects of the described functions using special-purpose hardware.

At 1205, the method may include receiving, via a user interface, a first user input comprising a first definition for a first set of data metrics configured for a tenant in a multi-tenant system. The operations of 1205 may be performed in accordance with examples as disclosed herein. In some examples, aspects of the operations of 1205 may be performed by a user input component 825 as described with reference to FIG. 8.

At 1210, the method may include receiving, via the user interface, a second user input comprising a second definition for a second set of data metrics configured for the tenant in the multi-tenant system. The operations of 1210 may be performed in accordance with examples as disclosed herein. In some examples, aspects of the operations of 1210 may be performed by a user input component 825 as described with reference to FIG. 8.

At 1215, the method may include receiving a real-time data stream associated with the tenant in the multi-tenant system. The operations of 1215 may be performed in accordance with examples as disclosed herein. In some examples, aspects of the operations of 1215 may be performed by a real-time data stream component 830 as described with reference to FIG. 8.

At 1220, the method may include determining that the second definition for the second set of data metrics includes a reference to the first definition for the first set of data metrics, wherein evaluating the one or more rules is based at least in part on the determining. The operations of 1220 may be performed in accordance with examples as disclosed herein. In some examples, aspects of the operations of 1220 may be performed by a rule evaluation component 835 as described with reference to FIG. 8.

At 1225, the method may include evaluating, in a batch manner, one or more rules based at least in part on ingesting the real-time data stream into the first definition for the first set of data metrics and the second definition for the second set of data metrics. The operations of 1225 may be performed in accordance with examples as disclosed herein. In some examples, aspects of the operations of 1225 may be performed by a rule evaluation component 835 as described with reference to FIG. 8.

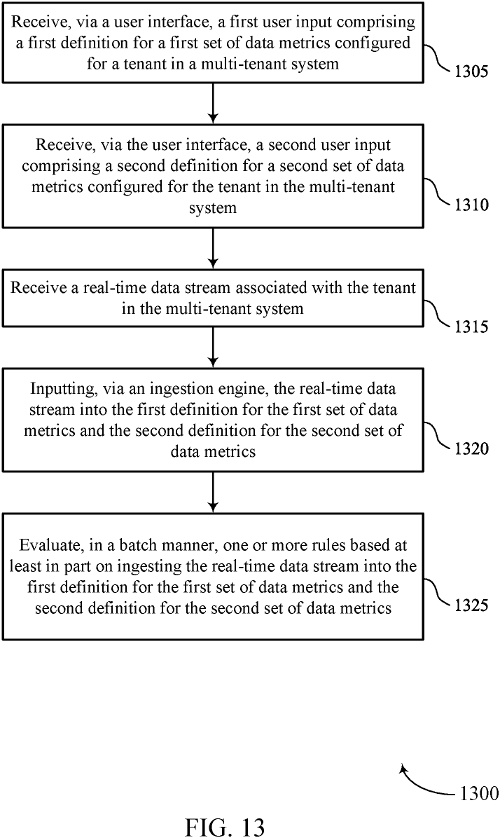

FIG. 13 shows a flowchart illustrating a method 1300 that supports rule evaluation for related data metrics in real-time data stream in accordance with aspects of the present disclosure. The operations of the method 1300 may be implemented by an application server or its components as described herein. For example, the operations of the method 1300 may be performed by an application server as described with reference to FIGS. 1 through 9. In some examples, an application server may execute a set of instructions to control the functional elements of the application server to perform the described functions. Additionally, or alternatively, the application server may perform aspects of the described functions using special-purpose hardware.

At 1305, the method may include receiving, via a user interface, a first user input comprising a first definition for a first set of data metrics configured for a tenant in a multi-tenant system. The operations of 1305 may be performed in accordance with examples as disclosed herein. In some examples, aspects of the operations of 1305 may be performed by a user input component 825 as described with reference to FIG. 8.

At 1310, the method may include receiving, via the user interface, a second user input comprising a second definition for a second set of data metrics configured for the tenant in the multi-tenant system. The operations of 1310 may be performed in accordance with examples as disclosed herein. In some examples, aspects of the operations of 1310 may be performed by a user input component 825 as described with reference to FIG. 8.

At 1315, the method may include receiving a real-time data stream associated with the tenant in the multi-tenant system. The operations of 1315 may be performed in accordance with examples as disclosed herein. In some examples, aspects of the operations of 1315 may be performed by a real-time data stream component 830 as described with reference to FIG. 8.

At 1320, the method may include inputting, via an ingestion engine, the real-time data stream into the first definition for the first set of data metrics and the second definition for the second set of data metrics. The operations of 1320 may be performed in accordance with examples as disclosed herein. In some examples, aspects of the operations of 1320 may be performed by an ingestion component 845 as described with reference to FIG. 8.

At 1325, the method may include evaluating, in a batch manner, one or more rules based at least in part on ingesting the real-time data stream into the first definition for the first set of data metrics and the second definition for the second set of data metrics. The operations of 1325 may be performed in accordance with examples as disclosed herein. In some examples, aspects of the operations of 1325 may be performed by a rule evaluation component 835 as described with reference to FIG. 8.

A method for data processing at an application server is described. The method may include receiving, via a user interface, a first user input comprising a first definition for a first set of data metrics configured for a tenant in a multi-tenant system, receiving, via the user interface, a second user input comprising a second definition for a second set of data metrics configured for the tenant in the multi-tenant system, receiving a real-time data stream associated with the tenant in the multi-tenant system, and evaluating, in a batch manner, one or more rules based at least in part on ingesting the real-time data stream into the first definition for the first set of data metrics and the second definition for the second set of data metrics.

An apparatus for data processing at an application server is described. The apparatus may include a processor, memory coupled with the processor, and instructions stored in the memory. The instructions may be executable by the processor to cause the apparatus to receive, via a user interface, a first user input comprising a first definition for a first set of data metrics configured for a tenant in a multi-tenant system, receive, via the user interface, a second user input comprising a second definition for a second set of data metrics configured for the tenant in the multi-tenant system, receive a real-time data stream associated with the tenant in the multi-tenant system, and evaluate, in a batch manner, one or more rules based at least in part on ingesting the real-time data stream into the first definition for the first set of data metrics and the second definition for the second set of data metrics.

Another apparatus for data processing at an application server is described. The apparatus may include means for receiving, via a user interface, a first user input comprising a first definition for a first set of data metrics configured for a tenant in a multi-tenant system, means for receiving, via the user interface, a second user input comprising a second definition for a second set of data metrics configured for the tenant in the multi-tenant system, means for receiving a real-time data stream associated with the tenant in the multi-tenant system, and means for evaluating, in a batch manner, one or more rules based at least in part on ingesting the real-time data stream into the first definition for the first set of data metrics and the second definition for the second set of data metrics.

A non-transitory computer-readable medium storing code for data processing at an application server is described. The code may include instructions executable by a processor to receive, via a user interface, a first user input comprising a first definition for a first set of data metrics configured for a tenant in a multi-tenant system, receive, via the user interface, a second user input comprising a second definition for a second set of data metrics configured for the tenant in the multi-tenant system, receive a real-time data stream associated with the tenant in the multi-tenant system, and evaluate, in a batch manner, one or more rules based at least in part on ingesting the real-time data stream into the first definition for the first set of data metrics and the second definition for the second set of data metrics.

Some examples of the method, apparatuses, and non-transitory computer-readable medium described herein may further include operations, features, means, or instructions for receiving, via the user interface, one or more rules corresponding to an action and triggering the action based at least in part on evaluating the one or more rules in the batch manner.

Some examples of the method, apparatuses, and non-transitory computer-readable medium described herein may further include operations, features, means, or instructions for receiving, via the user interface, a selection of a target for the action, wherein triggering the action comprises triggering the action at the target.

Some examples of the method, apparatuses, and non-transitory computer-readable medium described herein may further include operations, features, means, or instructions for determining that the second definition for the second set of data metrics includes a reference to the first definition for the first set of data metrics, wherein evaluating the one or more rules may be based at least in part on the determining.

Some examples of the method, apparatuses, and non-transitory computer-readable medium described herein may further include operations, features, means, or instructions for inputting, via an ingestion engine, the real-time data stream into the first definition for the first set of data metrics and the second definition for the second set of data metrics.

Some examples of the method, apparatuses, and non-transitory computer-readable medium described herein may further include operations, features, means, or instructions for receiving, via the user interface, one or more rules corresponding to an action, and triggering the action on a set of action destinations based on the one or more rules.

Some examples of the method, apparatuses, and non-transitory computer-readable medium described herein may further include operations, features, means, or instructions for storing the real-time data stream associated with the tenant in the multi-tenant system in a cache memory.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing at an application server, comprising:
receiving, via a user interface, a first user input comprising a first definition for a first set of data metrics configured for a tenant in a multi-tenant system;
receiving, via the user interface, a second user input comprising a second definition for a second set of data metrics configured for the tenant in the multi-tenant system;
receiving a real-time data stream associated with the tenant in the multi-tenant system; and
evaluating, in a batch manner, one or more rules based at least in part on ingesting the real-time data stream into the first definition for the first set of data metrics and the second definition for the second set of data metrics.

2. The method of claim 1, further comprising:
receiving, via the user interface, one or more rules corresponding to an action; and
triggering the action based at least in part on evaluating the one or more rules in the batch manner.

3. The method of claim 2, further comprising:
receiving, via the user interface, a selection of a target for the action, wherein triggering the action comprises triggering the action at the target.

4. The method of claim 1, further comprising:
determining that the second definition for the second set of data metrics includes a reference to the first definition for the first set of data metrics, wherein evaluating the one or more rules is based at least in part on the determining.

5. The method of claim 1, further comprising:
inputting, via an ingestion engine, the real-time data stream into the first definition for the first set of data metrics and the second definition for the second set of data metrics.

6. The method of claim 1, further comprising:
receiving, via the user interface, one or more rules corresponding to an action; and
triggering the action on a plurality of action destinations based at least in part on the one or more rules.

7. The method of claim 1, further comprising:
storing the real-time data stream associated with the tenant in the multi-tenant system in a cache memory.

8. An apparatus for data processing at an application server, comprising:
a processor;
memory coupled with the processor; and
instructions stored in the memory and executable by the processor to cause the apparatus to:
receive, via a user interface, a first user input comprising a first definition for a first set of data metrics configured for a tenant in a multi-tenant system;
receive, via the user interface, a second user input comprising a second definition for a second set of data metrics configured for the tenant in the multi-tenant system;
receive a real-time data stream associated with the tenant in the multi-tenant system; and
evaluate, in a batch manner, one or more rules based at least in part on ingesting the real-time data stream into the first definition for the first set of data metrics and the second definition for the second set of data metrics.

9. The apparatus of claim 8, wherein the instructions are further executable by the processor to cause the apparatus to:
receive, via the user interface, one or more rules corresponding to an action; and
trigger the action based at least in part on evaluating the one or more rules in the batch manner.

10. The apparatus of claim 9, wherein the instructions are further executable by the processor to cause the apparatus to:
receive, via the user interface, a selection of a target for the action, wherein triggering the action comprises triggering the action at the target.

11. The apparatus of claim 8, wherein the instructions are further executable by the processor to cause the apparatus to:
determine that the second definition for the second set of data metrics includes a reference to the first definition for the first set of data metrics, wherein evaluating the one or more rules is based at least in part on the determining.

12. The apparatus of claim 8, wherein the instructions are further executable by the processor to cause the apparatus to:
inputting, via an ingestion engine, the real-time data stream into the first definition for the first set of data metrics and the second definition for the second set of data metrics.

13. The apparatus of claim 8, wherein the instructions are further executable by the processor to cause the apparatus to:
receive, via the user interface, one or more rules corresponding to an action; and
trigger the action on a plurality of action destinations based at least in part on the one or more rules.

14. The apparatus of claim 8, wherein the instructions are further executable by the processor to cause the apparatus to:
store the real-time data stream associated with the tenant in the multi-tenant system in a cache memory.

15. A non-transitory computer-readable medium storing code for data processing at an application server, the code comprising instructions executable by a processor to:
receive, via a user interface, a first user input comprising a first definition for a first set of data metrics configured for a tenant in a multi-tenant system;
receive, via the user interface, a second user input comprising a second definition for a second set of data metrics configured for the tenant in the multi-tenant system;
receive a real-time data stream associated with the tenant in the multi-tenant system; and
evaluate, in a batch manner, one or more rules based at least in part on ingesting the real-time data stream into the first definition for the first set of data metrics and the second definition for the second set of data metrics.

16. The non-transitory computer-readable medium of claim 15, wherein the instructions are further executable by the processor to:
receive, via the user interface, one or more rules corresponding to an action; and
trigger the action based at least in part on evaluating the one or more rules in the batch manner.

17. The non-transitory computer-readable medium of claim 16, wherein the instructions are further executable by the processor to:
receive, via the user interface, a selection of a target for the action, wherein triggering the action comprises triggering the action at the target.

18. The non-transitory computer-readable medium of claim 15, wherein the instructions are further executable by the processor to:
determine that the second definition for the second set of data metrics includes a reference to the first definition for the first set of data metrics, wherein evaluating the one or more rules is based at least in part on the determining.

19. The non-transitory computer-readable medium of claim 15, wherein the instructions are further executable by the processor to:
inputting, via an ingestion engine, the real-time data stream into the first definition for the first set of data metrics and the second definition for the second set of data metrics.

20. The non-transitory computer-readable medium of claim 15, wherein the instructions are further executable by the processor to:
store the real-time data stream associated with the tenant in the multi-tenant system in a cache memory.
